(19) United States
(12) Patent Application Publication
(10) Pub. No.: US 2014/0247445 A1
(43) Pub. Date: Sep. 4, 2014

(54) CARTRIDGE FOR CONTAINING A SAMPLE

(71) Applicant: TOXIMET LIMITED, Sittingbourne, Kent (GB)

(72) Inventor: Raymond Coker, Kent (GB)

(73) Assignee: Toximet Limited, Kwnt (GB)

(21) Appl. No.: 13/261,876

(22) PCT Filed: Nov. 12, 2012
(86) PCT No.: PCT/GB2012/052801

§ 371 Date: May 14, 2014

(30) Foreign Application Priority Data
Nov. 14, 2011 (GB) 1119624.3

(51) Int. Cl. G01N 21/01

(52) U.S. Cl. CPC G01N 21/01
USPC 356/246

(57) ABSTRACT

The present invention relates to a cartridge for containing a sample, for example a sample to be analysed in an analyser such as a spectroscopic analyser. A cartridge for containing a sample to be analysed by an analyser such as a spectroscopic analyser, said cartridge comprising: an upper member including a reservoir; a lower member said upper and lower members being interconnected by a tube for containing the sample, and the lower member including a coupling for connection to a driven rotary means of said analyser whereby the cartridge may be rotated about its axis.

The present invention relates to a cartridge for containing a sample, for example a sample to be analysed in an analyser such as a spectroscopic analyser. Whilst we will describe a cartridge which is particularly useful for containing a sample in the form of food toxins such as aflatoxins or other mycotoxins, the cartridge may be used in the analysis of other compounds.

### BACKGROUND OF THE INVENTION

As a preferred embodiment of the invention we will describe a cartridge which is useful with the analyser described in our earlier co-pending International patent publication 2009/047549 but the invention is not restricted thereto.

As shown in that earlier patent specification, a sample to be analysed is immobilised within a transparent cartridge which may be of plastics or glass. In one example, the sample is stimulated to fluoresce, by illuminating radiation and the fluorescent radiation is collected by the analyser and analysed using a spectrometer. Other techniques such as Raman scattering, may be used.

Whilst such an arrangement operates effectively, it is preferable to try to improve the efficiency, accuracy, economy and effectiveness of the analysis. Cartridges illustrated in the earlier patent specification comprise either a glass tube expanded at the top to provide a wider part which can act as a reservoir or a lengthy tube with a simple saucer shaped flaring at its upper end which cannot act as a reservoir.

### SUMMARY OF THE INVENTION

According to a first aspect, the present invention provides a cartridge for containing a sample to be analysed by an analyser such as spectroscopic analyser, said cartridge comprising:
an upper member including a reservoir, the upper member preferably being of a mouldable material such as plastic, and being generally cylindrical in form;
a lower member preferably being formed of a mouldable material such as plastic,
said upper and lower members being interconnected by a tube (which may be formed of glass or plastics material) for containing the sample, and
the lower member including a coupling for connection to a driven rotary means of said analyser whereby the cartridge may be rotated about its axis.

By providing the upper and lower members separately from the tube, whereas in the past one might provide a glass tube and blow a reservoir at one end which limits the relative diameter of the tube and reservoir, the present invention can use a glass tube of a diameter not restricted by the diameter of the reservoir, one can use a tube of very narrow dimensions, typically 0.2-2.5 mm, preferably 1-1.6 mm and preferably substantially 1.55 mm inner diameter capillary tube.

The use of plastics material provides a robust tube, but the use of glass tube reduces or eliminates fluorescence in the material of the tube.

Using a very narrow tube enables one to utilise a small quantity of sample, concentrate the spread of the sample and hence increase the sensitivity of the analysis (the common amount of sample is concentrated over a narrow diameter disc on the immobilising layer of adsorbent) or enables one to measure smaller concentrations of sample. It also allows one to reduce the amount, and hence costs of the materials used in preparing the sample and the cartridge.

Preferably the lower member includes a means such as a hollow Luer fitting to connect the cartridge, and in particular the interior of the glass tube, to a vacuum supply whereby the vacuum may draw a sample from the reservoir into the glass tube.

The lower member may also include a fitting means to accurately mount the glass tube. This fitting means may extend axially to surround the glass tube and support it accurately so that the axis of the glass tube and cartridge coincide.

The lower member may also include a locking means to lock the cartridge with the rotary member of the analyser, the locking means being adapted so that the axis of the glass tube coincides with the axis of rotation of the rotary member.

In this way, the cartridge may be accurately mounted with respect to the axis of rotation of the rotary member of the analyser, and this may be arranged so as to accurately maintain the axis of the glass tube in correct alignment with the analyser.

In addition, the lower member may include a pin member to engage with the lower member and extend into the glass tube, the upper end of the pin member, when engaged with the lower member, being accurately positioned along the axis of cartridge in such a position that the upper end accurately defines the position of the sample in the glass tube.

The reservoir in the upper member may include an outlet at its base through which the sample may pass from the reservoir into the upper end of the glass tube. The angle of the wall of the reservoir adjacent said outlet with respect to the vertical is 10° and 15°, typically 13° being such that the sample readily flows from the reservoir through the outlet.

The upper member may also include a stopper connecting with the outlet of the reservoir, the stopper being mounted in the upper member so as to be moveable between a first position in which the stopper is positioned with respect to the outlet so liquid may flow from the reservoir into the upper end of the glass tube through the outlet, and a second position in which the stopper closes the outlet.

Further means may be provided to extend between the upper and lower members, said further means comprising a sheath, comprising an upper part to engage with the upper member, and a lower part to engage with or surround at least part of the lower member, and a wall member to generally surround the glass tube. In this way the surface of the glass tube may be protected from contamination until it is ready to be mounted in the analyser.

For ease of use, said sheath may be adapted to frictionally engage with the upper member, and may be adapted to surround the lower member, whereby it may easily be removed when the cartridge is to be mounted in the analyser.

The wall of the sheath may include apertures or transparent parts whereby some parts of the cartridge within may be viewed. For example, the level of the liquid or sample in the glass tube during loading may then be observed.

Said glass tube may, in use, contain a liquid porous spacer means to define the lower end of a immobilsing means, the immobilising means being of a material to entrap the material of the sample.

According to a second aspect, the present invention provides a cartridge for containing a sample to be analysed by an analyser such as spectroscopic analyser, said cartridge comprising:
an upper member including a reservoir;
a lower member,
said upper and lower members being interconnected by a tube for containing the sample, and
said tube having an inside diameter 0.2-2.5 mm, preferably 1-1.6 mm, preferably substantially 1.55 mm.

According to a third aspect, the present invention provides a cartridge for containing a sample to be analysed by an analyser such as spectroscopic analyser, said analyser including a rotary member, and said cartridge comprising:
an upper member including a reservoir;
a lower member,
said upper and lower members being interconnected by a tube for containing the sample, and
the lower member includes a means such as a hollow Luer fitting to connect the cartridge, and in particular the interior of the tube, to a vacuum supply whereby the vacuum may draw a sample form the reservoir into the tube, and the lower member also include a locking means to lock the cartridge with the rotary member of the analyser, the locking means being adapted so that the axis of the tube coincides with the axis of rotation of the rotary member.

According to a fourth aspect, the present invention provides a cartridge for containing a sample to be analysed by an analyser such as spectroscopic analyser, said analyser including a rotary member, and said cartridge comprising:
an upper member including a reservoir;
a lower member,
said upper and lower members being interconnected by a tube for containing the sample,
   said lower member including means to engage with said rotary member to thereby rotate said cartridge, and
the outer surface of the upper member being generally cylindrical and including means to cooperate with an adjacent surface of the analyser so as to maintain the upper member in an accurate transverse position in respect of the axis of rotation of the driven rotary member of the analyser.

Preferably said means to cooperate with an adjacent surface of the analyser comprises a ring extending around the outer surface of the upper member, the axis of the ring coinciding with the axis of the cartridge.

Preferably said ring is formed by an edge between two parts of said outer surface, the two parts being at a small angle to one another.

According to a fifth aspect, the present invention provides a cartridge for containing a sample to be analysed by an analyser such as spectroscopic analyser, said cartridge comprising:
an upper member including a reservoir;
a lower member,
said upper and lower members being interconnected by,a tube for containing the sample, and
   a sheath member to extend between the upper and lower members, said sheath member comprising a sheath, comprising an upper part to engage with the upper member, and a lower part to engage with or surround at least part of the lower member, and a wall member to generally surround the tube.

### BRIEF DESCRIPTION OF THE DRAWINGS

Preferred embodiments of the invention will now be described by way of example only and with reference to the accompanying drawings in which:

FIG. 1 is a perspective view of the assembled cartridge with sheath,

FIG. 2 is a perspective view of the assembled cartridge without a sheath,

FIG. 3 is an axial section of the assembled cartridge,

FIG. 4 is an axial exploded view of the cartridge,

FIG. 5 is an axial section of the upper member and glass tube, with a stopper in the reservoir in a first, open position,

FIG. 6 is an axial section of the upper member and glass tube, with the stopper in the reservoir in a second, closed position,

FIG. 7 is an axial section of the glass tube and lower member,

FIG. 8 is an axial section of the glass tube and lower member similar to FIG. 7 but with the addition of the sheath,

FIG. 9 is a perspective view from below of the lower member showing a coupling,

FIG. 10 is an enlarged side view of the upper end of the upper member,

FIG. 11 is an axial section of the cartridge mounted within an analyser, and

FIG. 12 is a perspective view of the end of a rotary member of the analyser,

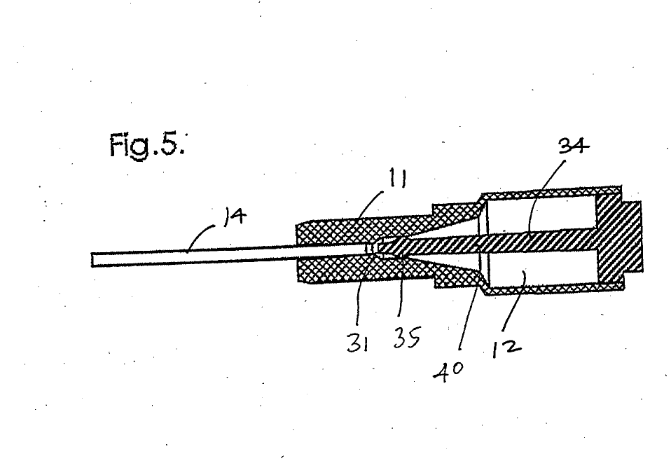

FIGS. 5-10 show only selected adjacent parts of the cartridge to make the drawings clearer.

### DETAILED DESCRIPTION OF THE PREFERRED EMBODIMENTS OF THE INVENTION

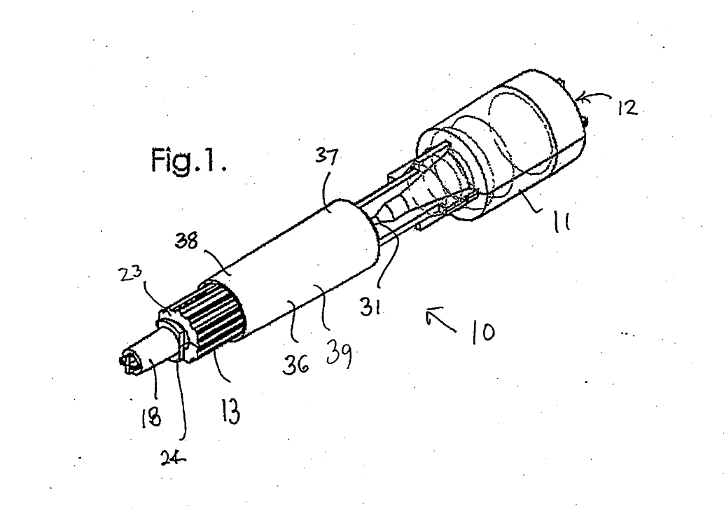

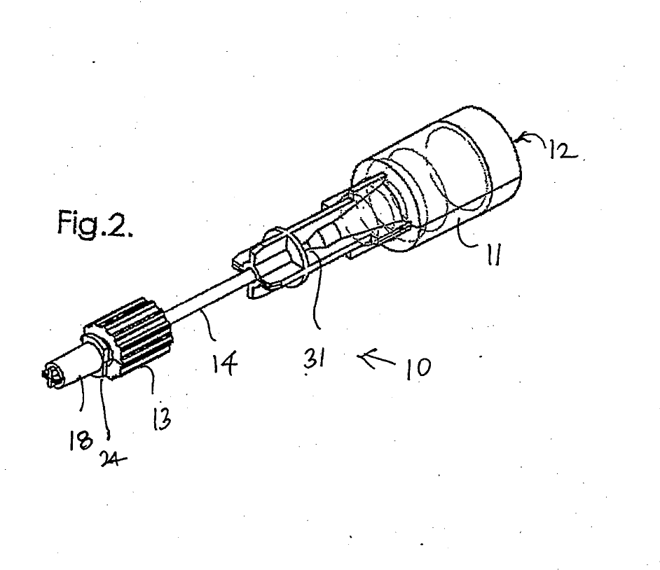

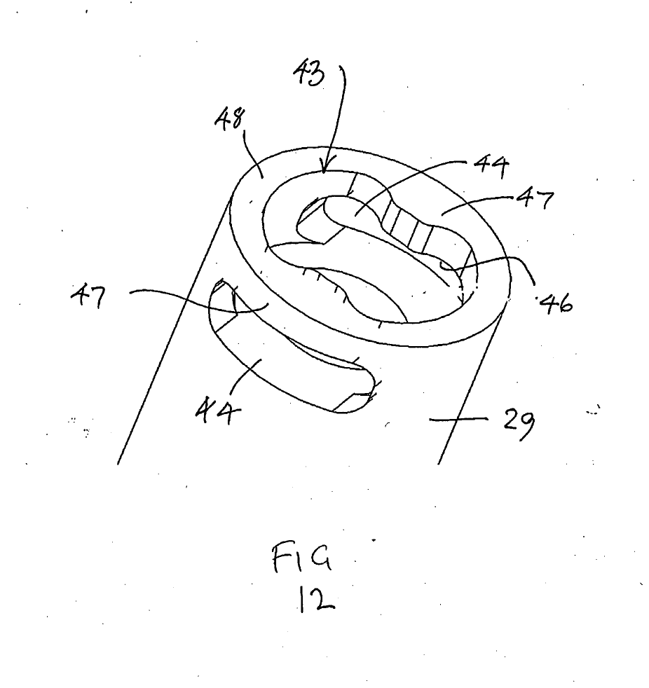

Referring to FIGS. 1 and 2 there is shown a cartridge 10 for containing a sample to be analysed by an analyser such as spectroscopic analyser 28 shown in section in FIG. 12. The cartridge 10 includes an upper member 11 of overall generally circular section, said upper member including a reservoir 12. The upper member is manufactured of moulded plastics material. The cartridge further comprises a lower member 13 also of plastic. The use of a mouldable material such as polypropylene allows for a complex shape of upper and lower members. The plastics material is transparent to allow one to see the liquid within.

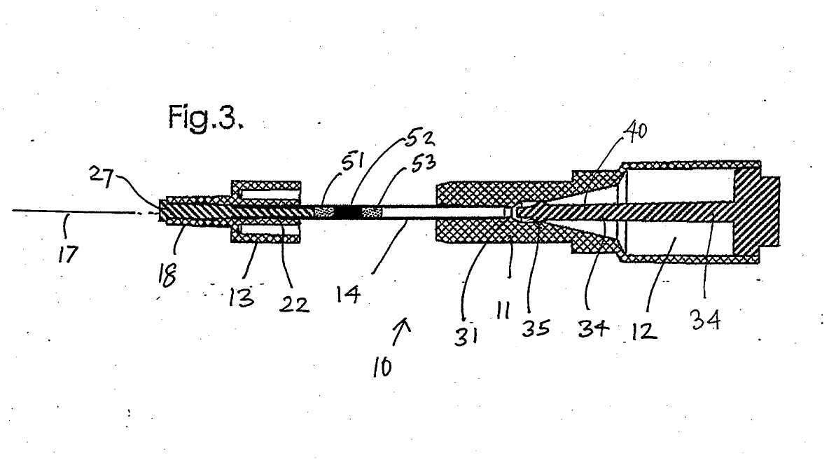

The upper and lower members are interconnected by a glass capillary tube 14 for containing the sample. The glass tube 14 is preferably of borosilicate glass and has an inner diameter typ2.5 mm. In the example illustrated the inner diameter is 1.55 mm and the outer diameter 2.5 mm. The lower member includes a coupling 18 for connection to a driven rotary member 29 of said analyser (see FIGS. 12 and 13) whereby rotation of the driven rotary member about its axis rotates the cartridge 10 about its axis 17 (FIG. 3) and similarly axial movement of the rotary member 29 is transmitted to the cartridge (for example when inserting the cartridge in the analyser when the rotary member is in an upper position and moving axially to a lower position in which the sample may be analysed and further small steps during analysis so the sample can be scanned along the axis of the cartridge).

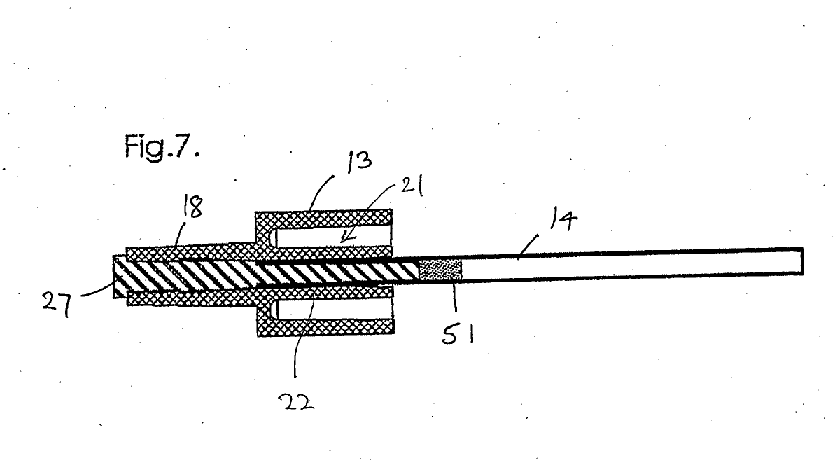

The lower member 13 includes a hollow Luer fitting 18 (see FIGS. 7-9) to connect the cartridge 10, and in particular the interior of the glass tube 14, to a vacuum manifold, or other source of vacuum supply, whereby the vacuum may draw liquid such as the sample from the reservoir 12 into the glass tube 14 (FIG. 2).

The lower member 13 also includes a fitting means to accurately mount the glass tube 14 with respect to the axis of the cartridge axis 17. This fitting means comprises a tubular section 22 of the moulding, the tubular section extending parallel to the axis 17 and having an inner diameter such that in assembly the outer diameter of the glass tube fits into the tubular section 22 in liquid tight fashion. In this way, the glass tube 14 is supported accurately so that the axis of the glass tube 14 and cartridge 10 coincide.

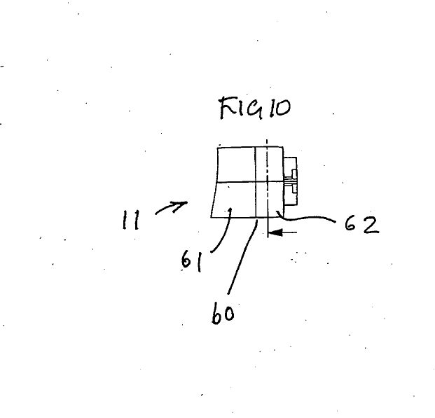

The lower member 13 also includes a locking means 24 (see FIG. 10) to lock the cartridge 10 with the rotary member 29 of the analyser. The locking means 24 comprises a pair of radially extending lugs 26.

Referring to FIG. 13, which shows a perspective view of the upper end of the rotary member 29 of the analyser 28 forming a metal coupling, there is shown a keyhole 43 of a section corresponding to the shape of the lugs 26 which keyhole extends axially into the end surface of the rotary member. Side slots 44 extend from the keyhole 43 to the circumferential surface of the rotary member and thereby provide bridge parts 47 and a formed surface 46 which defines the bottom of the keyhole 43. Thus, in use, the lugs 26 can pass into the keyhole 43 when correctly aligned therewith and then, by rotation of the cartridge 10, rotate into the slots 44 and hence under the bridge parts 47.

The formed surface 46 includes ramp surfaces which bring into contact the flat top 48 of the rotary member and the flat bottom 49 of the cartridge onto which the lugs 26 mate to lock the rotary member and cartridge together axially providing a “twist lock” action. In this way the cartridge will rotate and/or move axially with the rotary member 29.

In detail, the cartridge is held in a vertical position, within the bottom metal coupling, provided by the rotary member 29 by positively engaging the outer surface of the tapered, plastic male Luer fitting of the cartridge including the lugs 26 with the inner surface of the bottom metal coupling. The engagement of the two surfaces 48 and 49 previously described also ensures that the cartridge is held at a specific height within the bottom metal coupling. The cartridge is locked into position, within the bottom metal coupling by utilizing two lugs, which function as cams, to engage with the bottom metal coupling using a twist lock action. Finally, when in use, the cartridge is always rotated in a direction with retains tightness of the twist lock action.

In this way, the cartridge may be accurately mounted with respect to the axis of rotation of the rotary member 29 of the analyser, and this may be arranged so as to accurately maintain the axis of the glass tube in correct alignment with the axis of rotation of the rotary member during rotation. This is important so as maintain the part of the glass tube containing the sample in focus with the optical components.

In addition, the lower member 13 (FIGS. 3 & 4) mounts a pin 27 to engage with the lower member and extend into the glass tube 14. The pin 27 does not stop flow of liquid between the pin and inner surface of the glass tube. In one arrangement the pin 27 may be non-circular in form such as cruciform so as to allow liquid to freely pass down the glass tube past the pin.

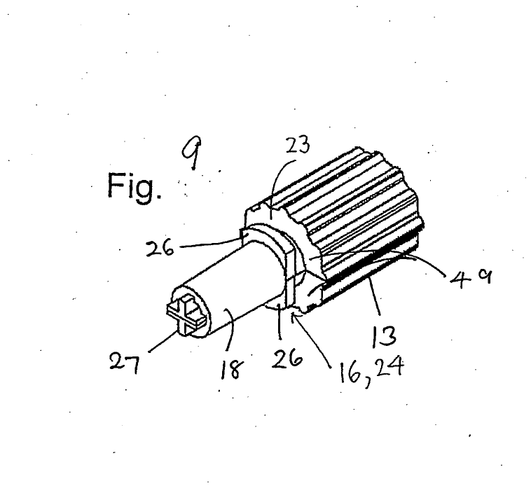

The upper end of the pin 27, when fully engaged with the lower member 13 (in the position illustrated in FIG. 9), is accurately positioned along the axis of cartridge in such a position that the upper end of the pin accurately defines the position of the sample in the glass tube.

The reservoir 12 in the upper member 11 includes an outlet 31 at its base which communicates with the open upper end of the glass tube through which the sample may pass from the reservoir into the upper end of the glass tube (FIG. 3). The angle of the wall of the reservoir adjacent said opening with respect to the vertical is 10° and 15°, typically 13°, being such that the sample readily flows from the reservoir through the outlet 31.

The outer surface of the upper member may be generally cylindrical and includes means to cooperate with an adjacent surface of the analyser so as to maintain the upper member in an accurate transverse position in respect of the axis of rotation of the driven rotary member of the analyser.

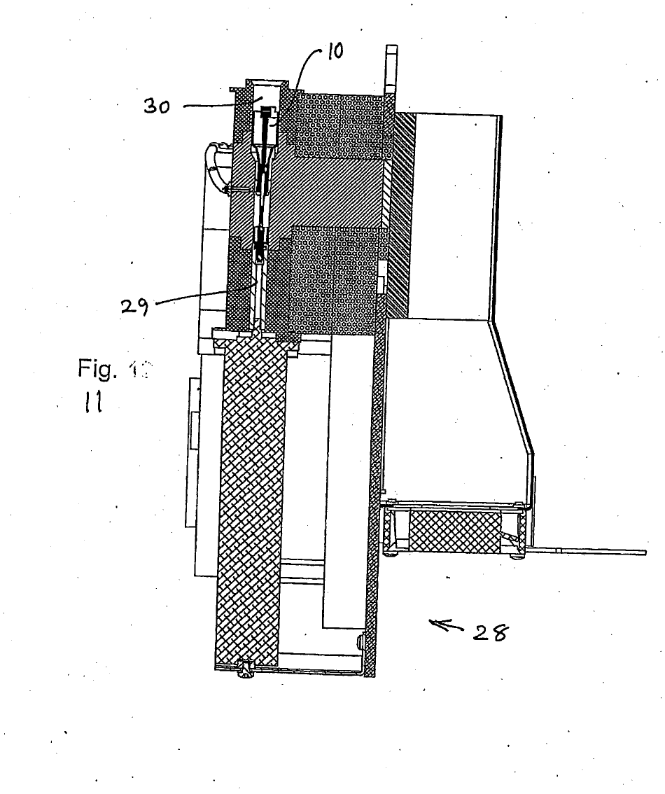

Said means to cooperate with an adjacent surface of the analyser comprises a ridge 60 (see FIG. 1 or 2 or 5 and in more detail in FIG. 11) extending around as a ring around the outer surface of the upper member, the axis of the ridge 60 coinciding with the axis of the cartridge. Said ridge is formed by an edge between two parts 61, 62 of said outer surface, the two parts being at a small angle typically 1° to one another. Said ridge 60 is adapted to cooperate with an adjacent cylindrical surface 33 (FIG. 12) of a chamber 30 in the analyser in which the cartridge is mounted so as to maintain the upper member 11 in an accurate transverse position in respect of the axis of rotation of the driven rotary means 29. Thus the ridge 60 may touch the cylindrical surface 33 if there is any misalignment but will usually be spaced by a small distance (typically 1 mm) therefrom. In that way, the glass tube 14 may be maintained in axial alignment with the axis of rotation of the driven rotary means 23 of the analyser whereby the sample is maintained in an accurate position transversely of the axis of the glass tube with respect to the analyser whilst the cartridge is rotated.

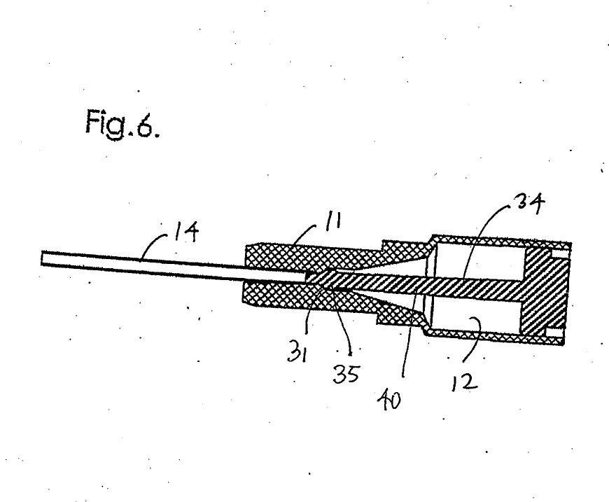

The upper member also includes a stopper 34 connecting with the outlet 31 of the reservoir, the stopper 34 being mounted in the upper member so as to be moveable between a first position (FIG. 3) in which the lower shaped end 35 is positioned with respect to the outlet 31 so liquid may flow from the reservoir into the upper end of the glass tube through the outlet, and a second position (FIG. 6) in which the lower shaped end 35 of the stopper closes the outlet. The stopper 34 includes a rod member 40 which extends to the upper end of the reservoir to allow for manual control of the position of the lower shaped lower end.

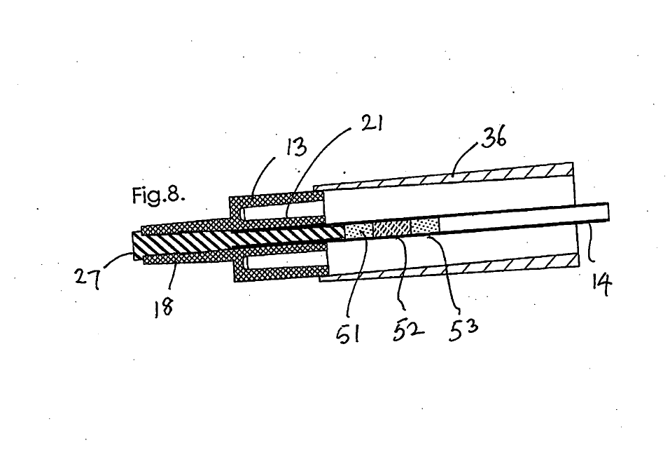

A sheath 36 may be provided to extend between the upper and lower members, (see FIGS. 1 and 8) said sheath comprising an upper part 37 to engage with the upper member 11, and a lower part 38 to engage with or surround at least part of the lower member 13, and a wall member 36 to generally surround the glass tube. In this way the outer surface of the glass tube may be protected from contamination until it is ready to be mounted in the analyser.

For ease of use, said sheath frictionally engages with the upper member, and may be adapted to surround the lower member, whereby it may easily be removed when the cartridge is to be mounted in the analyser.

In an alternative version of sheath (not shown), its upper end covers more of the upper member and in this case obscures a view of the outlet 31 and so the wall 39 of the sheath includes apertures or transparent parts whereby some parts of the cartridge including the outlet 31 may be viewed whilst the sheath is engaged with the cartridge. Thus the level of the liquid or sample in the reservoir or passing into the glass tube or in the glass tube during loading may then be observed.

In the illustrated arrangement, the sheath is shorter and does not reach the part of the upper member beyond the outlet 31 so there is no necessity for the apertures 41 or transparent window parts.

Said glass tube may, in use, contain a liquid porous spacer means 51 (hereafter referred to as a “frit”) to define the lower end of an immobilising layer 52; the immobilising layer 52 being of a material to adsorb the material of the sample to be detected and measured. A further frit 53 is provided above the immobilising layer.

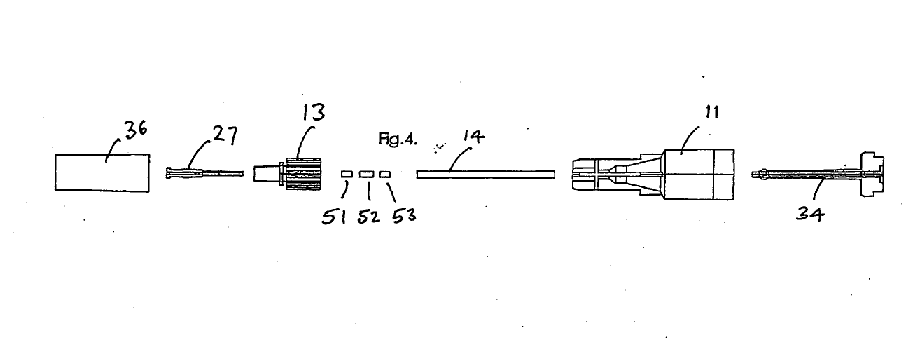

We will now describe the assembly of the cartridge and its use in an analyser, which may be most clearly understood from consideration of FIG. 4.

The component parts of the cartridge are assembled in a sequence with adjacent parts assembled together in an accurate and controlled manner using one or more jigs.

In a first step, the glass tube 14 and the lower member 13 (without the pin 27 engaged) may be engaged with one another. The actual engagement is preferably carried out by a suitable jig. The glass tube engages in the tubular section 22, which ensures that the glass tube is accurately aligned with the axis of the cartridge by the axial disposition of the tubular section 22 and is accurately aligned along the axis of the cartridge by means of the jig.

The upper end of the glass tube is then engaged in an axial socket 58 (see FIGS. 5 and 6) in the upper member 11 and engages with a shoulder 59 to define the position of the upper end of the glass tube with respect to the upper member 11. Once again this may be carried out by a suitable jig. The sockets 58 has a slight taper so as to engage with the outer diameter of the glass tube in a liquid sealing manner.

The frit 51 is then inserted via the upper member into the upper end of the glass tube, and pushed down by a jig member until it engages with the upper end of the pin 27 which thereby ensures it is in the correct axial position.

Adsorbent material which is in powder form may then be poured into the upper end of the glass tube via a funnel. An exact quantity (by weight or volume) of powdered material is poured into the reservoir 12 and by a suitable tapping or vibration or otherwise the powder passes down into the glass tube, and settles on the top surface of the lower frit 51 to form the immobilising layer 52.

It will be understood that by accurate measurement of the amount of powder added to the glass tube, and the fact that the glass tube has an accurate inside diameter, the position of the top surface of the powder and hence the immobilising layer 53 is determined.

As a next stage, an upper frit 53 is inserted via the reservoir into the upper end of the glass tube. A jig with a suitable pin pushes the upper frit 53 down to engage with the uppermost surface of the immobilising material.

The rod 40 is inserted into the upper member 11 in its first position (FIG. 5), where the lower shaped end 35 (FIG. 3) does not engage with the outlet 31. At some stage during this process the sheath 36 is engaged with the upper member 11 to protect the outer surface of the tube.

In this form, the cartridge may be stored ready for use.

In order to use the cartridge to analyse a sample, the immobilising layer 52 must be conditioned. The powdered material in the immobilising layer is initially dry and must be prepared so as to be able to absorb the toxin to be analysed. To do so, the cartridge is inserted into a vacuum manifold, or other source of vacuum supply, by means of the Luer fitting 18.

As a first step, 200 μl of 100% methanol is added to the reservoir. When vacuum is applied to the Luer fitting 18, vacuum is thereby applied to the interior of the glass tube 14, and hence to the outlet 31 of the reservoir, which draws the liquid down through the upper porous frit 53, through the immobilising layer 52, and through the lower porous frit 51. The effect of this is to wet the surface of the powder particulars, and also to wash out any impurities.

It will be understood that as inner diameter of the glass tube 14 is so narrow and because of the fineness of the immobilising layer, it typically takes several minutes for the liquid to be drawn from the reservoir through the immobilising layer.

As a second step, 200 μl of a methanol/water mixture, is drawn through under vacuum which thereby wets the surface of the powder with water (necessary as the toxin is in an aqueous solution).

As a third step, typically 0.1-50 ml, preferably 0.1-10 ml and more preferably 2 ml of a prepared aqueous solution of the sample material, the toxin, is added to the reservoir and under the vacuum is drawn down into the glass tube and hence through the immobilising layer 52. The sample in the form of the toxin is adsorbed by the immobilising layer 52 and is retained at the upper end of the immobilising layer 52. Effectively, therefore, the separated toxin is positioned as a flat disc, or immobilised layer, coincident with the top surface of the immobilising layer.

During this phase, it is desirable not to allow air above the aqueous solution and so as the top level of the toxin aqueous solution as seen by visual observation passes down past the outlet of the reservoir. Further aqueous methanol is added to the reservoir and the process of applying vacuum continues until the upper level of that water reaches the outlet 31. At that point the vacuum is turned off, and the stopper 34 is engaged fully so that the lower shaped end 35 engages with the outlet 31 to seal it.

Analysis of the toxin may now be carried out by inserting the cartridge into the chamber 30 of the analyser (see FIG. 11), and the coupling 16 of the lower member is engaged with the keyhole 43 as already described. In doing so, the Luer fitting 18 is engaged with a socket connected to the rotary member.

The immobilised layer of toxin is illuminated by radiation of such a wavelength to cause the immobilised layer of toxin to fluoresce, and the fluorescent radiation is passed to a spectrometer for analysis. During this process typically the cartridge is rotated by the rotary member 29 and at the end of each 360° rotation is stepped a short distance axially and the rotation repeated. In this way all of the toxin in the immobilising layer may be determined.

It will be understood that by providing the upper and lower members separately from the glass tube, whereas in the past one might provide a glass tube and blow a reservoir at one end which limits the relative diameter of the tube and reservoir, the present invention can use a glass tube of a diameter not restricted by the diameter of the reservoir, one can use a glass tube of very narrow dimensions, typically 1-1.5 mm inner diameter capillary tube. The use of a narrow glass tube reduces or eliminates fluorescence in the material of the tube, enables one to utilise a small quantity of sample, concentrate the spread of the sample and hence increase the sensitivity of the analysis, and reduce the amount, and hence costs of the materials used in preparing the sample and the cartridge.

The invention is not restricted to the details of the foregoing example.

For example, an advantage of the use of separate components is that components with different features may be used to make up the cartridge such as different size reservoirs.

Furthermore, the arrangement of immobilising layer described may be replaced by a multiple layer immobilising layer, the different layers having different properties to immobilise different compounds of interest, or can comprise a solid immobilising insert.

The tube 14 may be of a material other than glass, for example, plastic. Whilst glass usually has much better optical properties, in some circumstances the use of a plastic tube, which is more robust, is preferable despite its usually lesser optical properties.

1-33. (canceled)

34. A cartridge for containing a sample to be analysed by an analyser such as a spectroscopic analyser, said cartridge comprising:
an upper member including a reservoir;
a lower member
said upper and lower members being interconnected by a tube for containing the sample, and
the lower member including a coupling for connection to a driven rotary means of said analyser whereby the cartridge may be rotated about its axis.

35. A cartridge as claimed in claim 34 in which the lower member includes a means such as a hollow Luer fitting to connect the cartridge, and in particular the interior of the tube, to a vacuum supply whereby the vacuum may draw a sample from the reservoir into the tube, and the lower member also include a locking means to lock the cartridge with the rotary member of the analyser so that rotary motion of the rotary member is transmitted to the cartridge and the axis of the tube coincides with the axis of rotation of the rotary member.

36. A cartridge as claimed in claim 34 in which the outer surface of the upper member is generally cylindrical and includes means to cooperate with an adjacent surface of the analyser so as to maintain the upper member in an accurate transverse position in respect of the axis of rotation of the driven rotary member of the analyser.

37. A cartridge as claimed in claim 34 in which there is provided a sheath member to extend between the upper and lower members, said sheath member comprising an upper part to engage with the upper member, and a lower part to engage with or surround at least part of the lower member, and a wall member to generally surround the tube.

38. A cartridge as claimed in claim 34 in which the lower member includes a means to connect the interior of the tube to a vacuum supply whereby the vacuum may draw a sample from the reservoir into the tube.

39. A cartridge as claimed in claim 34 in which the means to connect the interior of the tube to a vacuum supply comprises a hollow Luer fitting.

40. A cartridge as claimed in claim 34 in which the lower member includes a socket to accurately mount the tube so that the axis of the tube is in a predetermined relationship to the lower member.

41. A cartridge as claimed in claim 34 in which said tube contains a liquid porous spacer means to define the lower end of an immobilising means, the immobilising means being of a material to entrap the material of the sample.

42. A cartridge as claimed in claim 34 in which the tube includes a immobilising means therein to immobilise the compound(s) of interest.

43. A cartridge as claimed in claim 42 in which the immobilising means is a layer is mounted within the tube between two frits.

44. A cartridge as claimed in claim 34 in which the lower member includes a pin member to engage with the lower member and extend into the tube, the upper end of the pin member, when engaged with the lower member, being accurately positioned along the axis of cartridge in such a position that the upper end accurately defines the position of the sample in the tube.

45. A cartridge for containing a sample to be analysed by an analyser such as a spectroscopic analyser, said analyser including a rotary member, and said cartridge comprising:
an upper member including a reservoir;
a lower member,
said upper and lower members being interconnected by a tube for containing the sample, and
the lower member includes a means such as a hollow Luer fitting to connect the cartridge, and in particular the interior of the tube, to a vacuum supply whereby the vacuum may draw a sample from the reservoir into the tube, and the lower member also include a locking means to lock the cartridge with the rotary member of the analyser so that rotary motion of the rotary member is transmitted to the cartridge and the axis of the tube coincides with the axis of rotation of the rotary member.

46. A cartridge as claimed in claim 45 in which said sheath is adapted to frictionally engage with the upper member, and is adapted to surround the lower member, whereby it may easily be removed when the cartridge is to be mounted in the analyser.

47. A cartridge as claimed in claim 45 in which the wall of the sheath include apertures or transparent parts whereby some parts of the cartridge within may be viewed.

48. A cartridge as claimed in claim 45 in which the locking means is adapted to transmit axial movement of the rotary member to the cartridge.

49. A cartridge for containing a sample to be analysed by an analyser such as a spectroscopic analyser, said analyser including a rotary member, and said cartridge comprising:
an upper member including a reservoir;
a lower member,
said upper and lower members being interconnected by a tube for containing the sample, said lower member including means to engage with said rotary member to thereby rotate said cartridge, and
the outer surface of the upper member being generally cylindrical and including means to cooperate with an adjacent surface of the analyser so as to maintain the upper member in an accurate transverse position in respect of the axis of rotation of the driven rotary member of the analyser.

50. A cartridge as claimed in claim 49 in which said means to cooperate with an adjacent surface of the analyser comprises a ridge extending around the outer surface of the upper member, the axis of the ridge coinciding with the axis of the cartridge.

51. A cartridge as claimed in claim 49 in which said ridge is formed by an edge between two parts of said outer surface, the two parts being at a small angle to one another.

52. A cartridge as claimed in claim 49 in which the lower member includes a coupling for connection to a driven rotary means of said analyser whereby the cartridge may be rotated about its axis.

53. A cartridge for containing a sample to be analysed by an analyser such as a spectroscopic analyser, said cartridge comprising:
an upper member including a reservoir;
a lower member,
said upper and lower members being interconnected by a tube for containing the sample, and
a sheath member to extend between the upper and lower members, said sheath member comprising an upper part to engage with the upper member, and a lower part to engage with or surround at least part of the lower member, and a wall member to generally surround the tube.
